(19) United States
(12) Patent Application Publication
(10) Pub. No.: US 2006/0077410 A1
(43) Pub. Date: Apr. 13, 2006

(54) BT/USB image-printing converter and the converting method

(75) Inventors: Wei-Hsiang Liao, Taipei (TW); Jun-Dan Chen, Taipei (TW)

Correspondence Address: APEX JURIS, PLLC, LAKE CITY CENTER, SUITE 410, 12360 LACE CITY WAY NORTHEAST, SEATTLE, WA, 98125, US

(73) Assignee: Lite-On Technology Corporation, Taipei (TW)

(21) Appl. No.: 10/961,424

(22) Filed: Oct. 7, 2004

(51) Int. Cl. G06F 15/00

(52) U.S. Cl. 358/1.13; 358/1.15

(57) ABSTRACT

A BT/USB image-printing converter and the method use a Bluetooth transmission module to receive image data from electronic products. According to a picture bridge protocol, the microprocessor converts the image data into printing data, which are then transmitted via a USB transmission module to the printing device. The printing of the image data is provided by electronic products without the aid of any computer device.

### BACKGROUND OF THE INVENTION

1. Field of Invention

The invention relates to a BT/USB image-printing converter and the method using the same. In particular, the invention relates to a BT/USB image-printing converter and the associated method that directly transmit image data from electronic products to the printing device.

2. Related Art

The Bluetooth technology is an open wireless communication standard that is widely used in many electronic products, such as notebook computers, personal digital assistants (PDA's), mobile phones, digital cameras, and even home appliances. The Bluetooth technology performs short-distance data exchanges in a wireless way. This technology uses the public channel (2.4 GHz) in order for different digital devices to communicate in a wireless way, making complicated signal lines history.

The camera and videotaping functions become popular in small electronics such as PDA's and mobile phones. If one wants to print the image data stored in such electronics with the Bluetooth transmission function, one usually has to upload the image data to a notebook computer or desktop computer and then print the image data to a printer using the printer driver. The image data uploading task is mostly accomplished using a converter. For example, D-LINK DBT-120 “Bluetooth 2.4 GHz USB Adapter for PC/MAC” has been sold on the market. The converter is connected to a computer via a universal serial bus (USB). Its main function is to enable data transmissions among electronic products with the Bluetooth technology and normal computer devices.

The above describes a common image data printing procedure for Bluetooth electronic products. However, it has certain drawbacks. The reason is that one has to use a notebook or desktop computer as a relay medium, first receiving the image data from an electronic device and then sending it to a printer using an appropriate printer driver. This is rather cumbersome. That is, it is impossible to directly print the data stored inside the electronic device without the assistance of a notebook or desktop computer. Moreover, the user usually has to wait a while for the computer to power on and make sure that the printer driver is correctly installed. This complicated and tedious procedure is quite difficult for ordinary computer users.

### SUMMARY OF THE INVENTION

In view of the foregoing, the invention provides a BT/USB image-printing converter and the associated method for printing devices. The invention provides a means to directly send image data stored in a Bluetooth electronic product to a printing device for printing without using a computer.

The invention provides a converting medium suitable for ordinary printing devices. Although some printing devices already have the Bluetooth function, yet such a function is still unpopular. Since USB data transmissions has become a transmission standard for printing devices, the disclosed BT/USB image-printing converter can be directly plugged into the USB of a printing device and receives the image data transmitted form the Bluetooth electronic product, without using any computer device. Therefore, the invention is applicable to printing devices without the Bluetooth function.

The disclosed BT/USB image-printing converter mainly consists of a Bluetooth transmission module, a microprocessor, and an USB transmission module. The Bluetooth transmission module receives image data transmitted from a Bluetooth electronic product. The microprocessor connects to the Blue transmission module for converting the image data into printing data. The USB transmission module connects to the microprocessor and the printing device to transmit the printing data to the printing device for printing.

The invention further discloses a BT/USB image-printing converting method. Image data transmitted from an electronic product is received using the Bluetooth technology. The image information for printing is extracted from the image data. The image information is then converted into printing data according to the picture bridge protocol. Finally, the printing data are transmitted to the printing device for printing.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the system structure of the disclosed BT/USB image-printing converter; and

FIG. 2 is a schematic flowchart of the disclosed BT/USB image-printing conversion method.

### DETAILED DESCRIPTION OF THE INVENTION

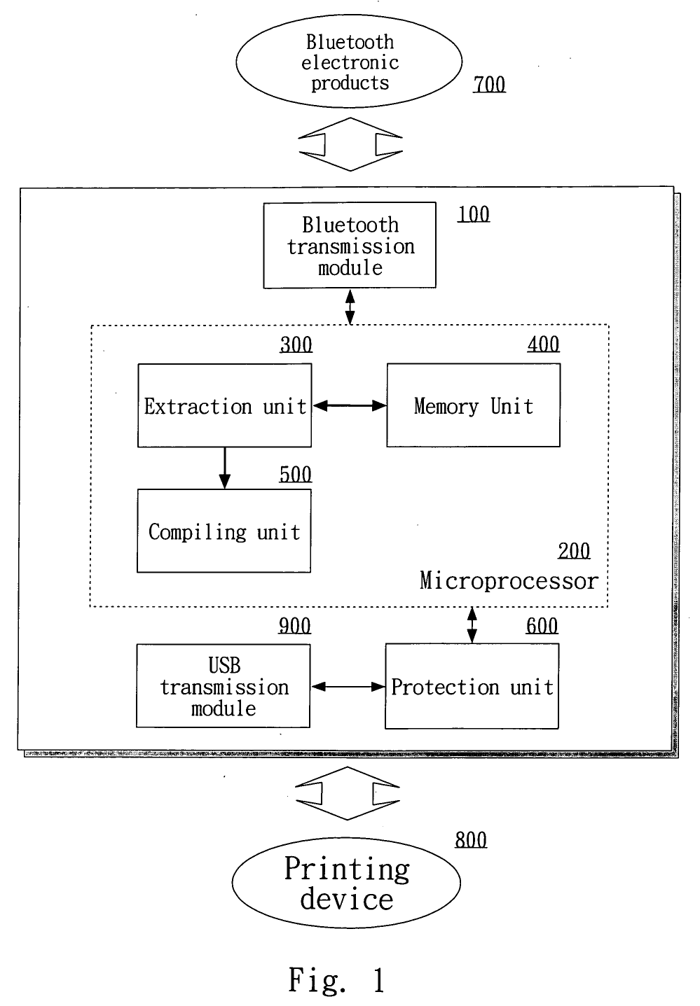

The system structure of the invention is shown in FIG. 1. The disclosed BT/USB image-printing converter can receive image data transmitted from a Bluetooth electronic product. The image data can be directly sent to a printing device for printing without needing any computer device. In the following, we explain the main components and relevant devices of the invention.

(1) Bluetooth transmission module 100. It is used to receive image data transmitted from Bluetooth electronic product 700 such as mobile phones and PDA's.

(2) Microprocessor 200. It is connected to the Bluetooth transmission module 100 and contains an extraction unit 300, a memory unit 400, and a compiling unit 500. The memory unit 400 temporarily stores the image data for subsequent uses. The extraction unit 300 extracts the image information to be printed from the image data transmitted by the Bluetooth electronic product 700. The image information to be printed can be in the OPP (Object Push Profile), BIP (Basic Imaging Profile), and BPP (Basic Printing Profile) formats. The compiling unit 500 converts the image information extracted from the image data into printing data according to the picture bridge protocol. The picture bridge protocol is a printing protocol development in the industry in recent years. It enables the data transmissions among different types of electronic products and printing devices.

(3) USB transmission module 900. It is connected to the microprocessor 200 and in electrical communications with the USB of the printing device 800. It can transmit the printing data provided by the microprocessor 200 to the printing device 800 for printing.

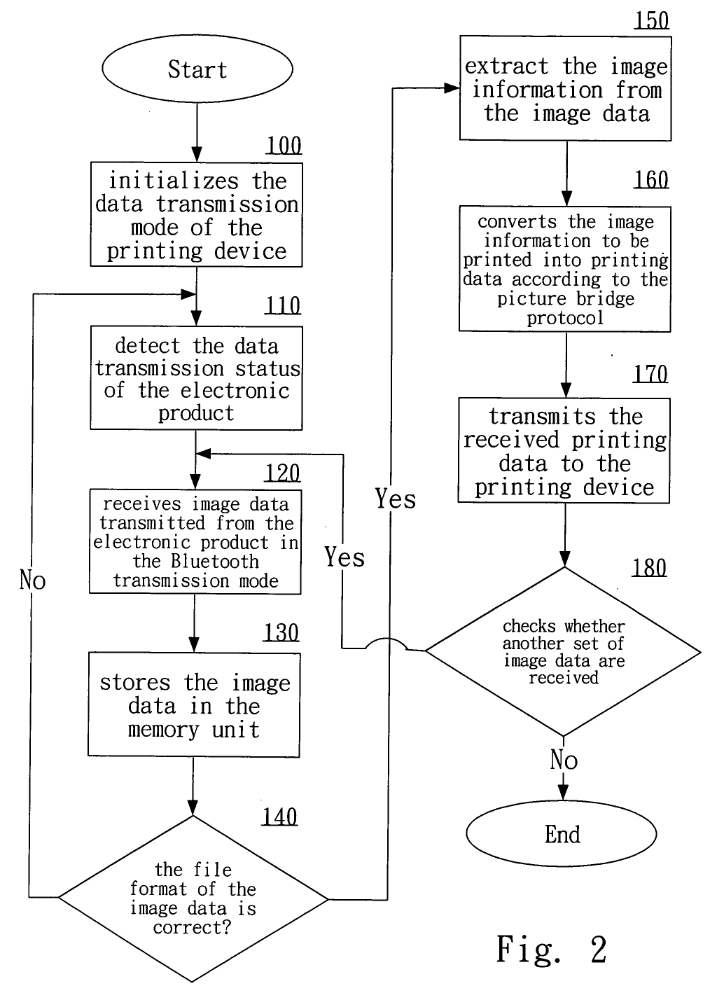

(4) Protection unit 600. It is electrically coupled to the microprocessor 200 and the USB transmission module 900. It is used to prevent the USB transmission module 900 from transmitting too much electric power to the microprocessor 200 to cause damages. The invention further discloses a BT/USB image-printing conversion method, whose primary procedure is outlined in FIG. 2.

After each printing element in the printing device is confirmed to return its initial position, the data transmission mode of the printing device is initialized (step 100) to get ready for receiving external information. The bluetooth transmission module continues to detect the data transmission status of the electronic product (step 110). Once the electronic product starts to transmit data, the system receives image data transmitted from the electronic product by using the Bluetooth transmission function (step 120) and temporarily stores the image data in the memory unit (step 130). Afterwards, the system detects the file format of the image data (step 140). If the data reception is incomplete or the file format is incorrect, the system returns to step 110 to receive another set of image data or request new transmissions. If the file format of the image data is correct, the extraction unit 300 extracts the image information to be printed from the image data (step 150). The image information to be printed can be in the OPP (Object Push Profile), BIP (Basic Imaging Profile) or BPP (Basic Printing Profile) formats. After step 150, the system converts the image information to be printed into printing data according to the picture bridge protocol (step 160). The picture bridge protocol is a printing protocol development in the industry in recent years. It enables the data transmissions among different types of electronic products and printing devices. After step 160, the system printing task starts after the system transmits the received printing data to the printing device (step 170). Finally, the system checks whether another set of image data are received (step 180). If so, the system goes back to step 120; otherwise, the whole procedure ends.

The disclosed BT/USB image-printing converter and the associated method can solve the problems encountered in the prior art, where one has to rely on the assistance of a computer device and proper installation of a printer driver in order to transmit image data from Bluetooth electronics to a printer. Using the invention, the data can be directly transmitted from a Bluetooth electronic product, such as the mobile phone, digital camera, and PDA, to a printing device for printing without the need of a computer.

Certain variations would be apparent to those skilled in the art, which variations are considered within the spirit and scope of the claimed invention.

What is claimed is:

1. A BT/USB image-printing converter for a printing device, which comprises:
a Bluetooth transmission module, which receives image data transmitted from an electronic product by using a Bluetooth transmission function;
a microprocessor, which connects to the Blue transmission module to convert the image data into printing data; and
an universal serial bus (USB) transmission module, which connects to the microprocessor and is electrically coupled to the printing device for transmitting the printing data to the printing device.

2. The BT/USB image-printing converter of claim 1, wherein the microprocessor contains a memory unit for temporarily storing the image data.

3. The BT/USB image-printing converter of claim 1, wherein the microprocessor contains an extraction unit to extract image information to be printed from the image data.

4. The BT/USB image-printing converter of claim 3, wherein the image information to be printed is in the OPP (Object Push Profile) format.

5. The BT/USB image-printing converter of claim 3, wherein the image information to be printed is in the BIP (Basic Imaging Profile) format.

6. The BT/USB image-printing converter of claim 3, wherein the image information to be printed is in the BPP (Basic Printing Profile) format.

7. The BT/USB image-printing converter of claim 3, wherein the microprocessor contains a compiling unit for converting the image information to be printed into the printing data according to the picture bridge protocol (PBP).

8. The BT/USB image-printing converter of claim 1 further comprising a protection unit electrically coupling to the microprocessor and the USB transmission module to prevent the USB transmission module from transmitting too much electric power to the microprocessor.

9. The BT/USB image-printing converter of claim 1, wherein the format of the printing data is compliant with the PBP.

10. A BT/USB image-printing conversion method for a printing device coupled to a Bluetooth electronic product, comprising the steps of:
receiving image data transmitted from the electronic product using the Bluetooth transmission function;
extracting image information to be printed from the image data;
converting the image information to be printed into printing data according to the picture bridge protocol (PBP); and
transmitting the printing data to the printing device.

11. The BT/USB image-printing conversion method of claim 10 further comprising, before the step of receiving image data transmitted from the electronic product using the Bluetooth transmission, the steps of:
initializing the data transmission mode of the printing device; and
detecting the data transmission status of the electronic product.

12. The BT/USB image-printing conversion method of claim 10, wherein the step of receiving image data transmitted from the electronic product using the Bluetooth transmission contains the steps of:
temporarily storing the image data in a memory unit; and
checking the file format of the image data.

13. The BT/USB image-printing conversion method of claim 10, wherein the step of converting the image information to be printed into printing data according to the PBP contains the step of checking the file format of the printing data.

14. The BT/USB image-printing conversion method of claim 13, wherein the image information to be printed is in the OPP (Object Push Profile) format.

15. The BT/USB image-printing conversion method of claim 13, wherein the image information to be printed is in the BIP (Basic Imaging Profile) format.

16. The BT/USB image-printing conversion method of claim 13, wherein the image information to be printed is in the BPP (Basic Printing Profile) format.
